(19) United States
(12) Patent Application Publication
(10) Pub. No.: US 2023/0158698 A1
(43) Pub. Date: May 25, 2023

(54) ADJUSTABLE COMPARTMENT FOOD SLICER SAFETY DEVICE WITH BLADE GUARD

(71) Applicant: Mexico Foods, LLC, Garland, TX (US)

(72) Inventor: Virgilio Aguilar, Garland, TX (US)

(21) Appl. No.: 17/989,147

(22) Filed: Nov. 17, 2022

Related U.S. Application Data
(60) Provisional application No. 63/282,361, filed on Nov. 23, 2021.

(51) Int. Cl. B26D 7/01

(52) U.S. Cl. CPC B26D 7/01

(57) ABSTRACT

An adjustable compartment food slicer safety device with blade guard includes a main box-like compartment, an adjustable pusher plate, a divider plate, and a lid. The device can be secured to band saw tables and has an adjustable blade guard, to improve user safety and meat processing efficiency.

### PRIORITY CLAIM AND CROSS-REFERENCE TO RELATED APPLICATIONS

The present application claims priority and benefit of U.S. Provisional Patent App. No. 63/282,361 filed Nov. 23, 2021, titled ADJUSTABLE COMPARTMENT FOOD SLICER SAFETY DEVICE WITH BLADE GUARD, the entire contents of which are incorporated by reference herein and relied upon.

### FIELD

The present disclosure relates generally to safety devices for food slicers. More specifically, this disclosure relates to a prefabricated metal container with a removable lid, an insertable pusher plate, an insertable divider plate, stabilizers, and a blade guard, to improve safety when cutting meat using a band saw.

### BACKGROUND

Modern butchery and related meat processing services typically implement band saws to cut meat quickly and uniformly. However, band saws pose risks for serious injuries such as hand amputations and deep wounds. Band saws themselves offer little-to-no safeguards. The most common safety device used with band saws is a blade guard.

Unfortunately, current safety technology is cumbersome and actually restricts band saw access when cutting meats. Band saw guards can cover the majority of the blade, giving the user very little room for cutting. Currently, the user needs to hold the meat and pass it through the band saw blade. While doing so, the user's hands get very close to the blade. Additionally, when the user processes irregularly-shaped or bone-in meats, bones can easily snap or the user can lose grip, which could lead to injuries. Current technology also requires the user to directly touch meat when processing it. The user must wear vinyl gloves, because meat is typically frozen; band saw blades can snag fabric or metal mesh gloves. Manually holding wet or cold meat could result in slipping, again, leading to injuries.

Safety devices that do not restrict blade access, while simultaneously securing irregular and bone-in meats, keeping the user's hands at a distance from blades, and avoiding direct manual contact with cold or frozen meats are therefore needed.

### SUMMARY

The adjustable compartment food slicer safety device with blade guard disclosed herein improves on food slicer safety technology by implementing a box-like device into which different-sized meats can be placed and secured. The safety device may be fixed to a band saw table, and may include a blade guard and a pusher plate. This safety device advantageously provides the user with the ability to securely feed meat into a band saw for cutting while minimizing direct manual contact with meat during the cutting process and maximizing hand distance from band saw blade, thus increasing overall user safety and meat processing efficiency.

In light of the disclosure herein, and without limiting the scope of the invention in any way, in a first aspect of the present disclosure, which may be combined with any other aspect listed herein unless specified otherwise, a safety device that has a main compartment, a blade guard, a pusher plate, a divider plate, and a compartment lid.

In a second aspect of the present disclosure, which may be combined with any other aspect listed herein unless specified otherwise, the main compartment, the blade guard, the pusher plate, the divider plate, and the compartment lid are comprised of metal.

In a third aspect of the present disclosure, which may be combined with any other aspect listed herein unless specified otherwise, the pusher plate includes a first side that includes a plurality of protrusions, and a second side that is flat.

In a fourth aspect of the present disclosure, which may be combined with any other aspect listed herein unless specified otherwise, the second, flat side of the pusher plate is configured to be coupled with a first removable handle.

In a fifth aspect of the present disclosure, which may be combined with any other aspect listed herein unless specified otherwise, the pusher plate is configured to be coupled to the main compartment via a slot and a latch.

In a sixth aspect of the present disclosure, which may be combined with any other aspect listed herein unless specified otherwise, the divider plate is configured to be coupled with a second removable handle.

In a seventh aspect of the present disclosure, which may be combined with any other aspect listed herein unless specified otherwise, the second removable handle is coupled to the main compartment via a fastening mechanism.

In an eight aspect of the present disclosure, which may be combined with any other aspect listed herein unless specified otherwise, the compartment lid interlocks with the main compartment.

In a ninth aspect of the present disclosure, which may be combined with any other aspect listed herein unless specified otherwise, the compartment lid may be disposed in an open position or in a closed position, relative to the main compartment.

In a tenth aspect of the present disclosure, which may be combined with any other aspect listed herein unless specified otherwise, the compartment lid is perforated.

In an eleventh aspect of the present disclosure, Which may be combined with any other aspect listed herein unless specified otherwise, the main compartment is comprised of a bottom, a back side, and two sides, and an open front.

In a twelfth aspect of the present disclosure, which may be combined with any other aspect listed herein unless specified otherwise, the back side and the two sides of the main compartment are perforated.

In a thirteenth aspect of the present disclosure, which may be combined with any other aspect listed herein unless specified otherwise, the main compartment is configured to be secured to a band saw table.

In a fourteenth aspect of the present disclosure, which may be combined with any other aspect listed herein unless specified otherwise, the blade guard is configured to be secured onto one of the two sides of the main component.

In a fifteenth aspect of the present disclosure, which may be combined with any other aspect listed herein unless specified otherwise, the main compartment, the blade guard, the pusher plate, the divider plate, and the compartment lid are comprised of a non-metal, durable material.

In a sixteenth aspect of the present disclosure, which may be combined with any other aspect listed herein unless specified otherwise, a blade guard configured to be disposed on a safety device, the blade guard including a support bracket and a blade receptacle that is disposed perpendicular to a bottom of the safety device when the blade receptacle receives a portion of a blade.

In a seventeenth aspect of the present disclosure, which may be combined with any other aspect listed herein unless specified otherwise, the support bracket is coupled to the blade receptacle at a mid-point of the blade receptacle.

In a eighteenth aspect of the present disclosure, which may be combined with any other aspect listed herein unless specified otherwise, the safety device includes an aperture configured to receive the support bracket.

In a nineteenth aspect of the present disclosure, which may be combined with any other aspect listed herein unless specified otherwise, the aperture is disposed along a side of the safety device.

in a twentieth aspect of the present disclosure, Which may be combined with any other aspect listed herein unless specified otherwise, the blade receptacle receives the portion of the blade after the blade has passed across a front of the safety device.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been selected for readability and instructional purposes, and not to limit the scope of the inventive subject matter.

### BRIEF DESCRIPTION OF THE FIGURES

Understanding that figures depict only typical embodiments of the invention and are not to be considered to be limiting the scope of the present disclosure, the present disclosure is described and explained with additional specificity and detail through the use of the accompanying figures. The figures are listed below.

FIG. 1 illustrates a perspective view of an assembled adjustable compartment food slicer safety device with blade guard, according to an example embodiment of the present disclosure.

FIG. 2 illustrates a perspective view of a box of a food slicer safety device, according to an example embodiment of the present disclosure.

FIG. 3 illustrates a perspective view of a pusher plate of a food slicer safety device, according to an example embodiment of the present disclosure.

FIG. 4 illustrates a perspective view of an assembled food slicer safety device with a divider plate installed, according to an example embodiment of the present disclosure.

FIG. 5 illustrates a perspective view of an assembled food slicer safety device, according to an example embodiment of the present disclosure.

FIG. 6 illustrates two perspective views of a blade guard of a food slicer safety device, according to an example embodiment of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

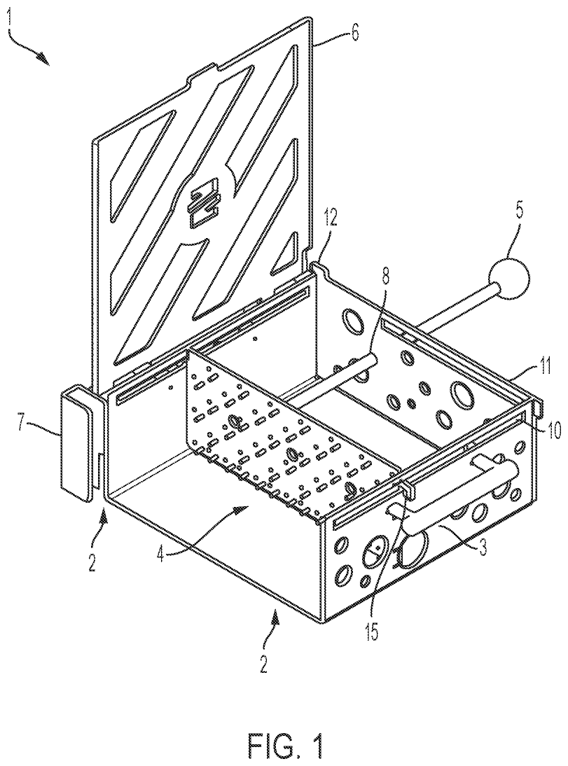

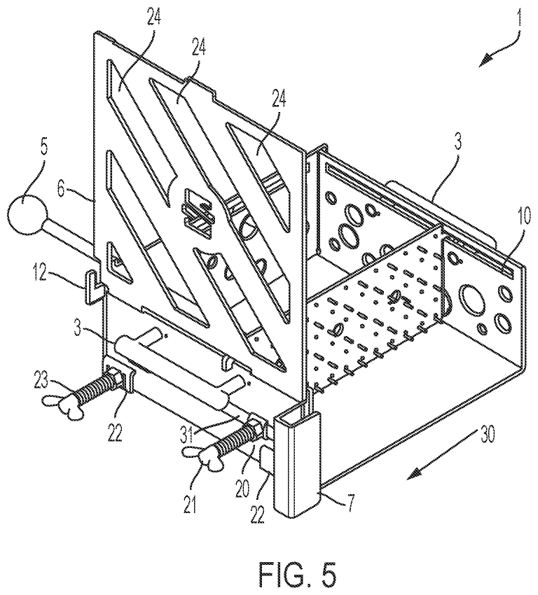

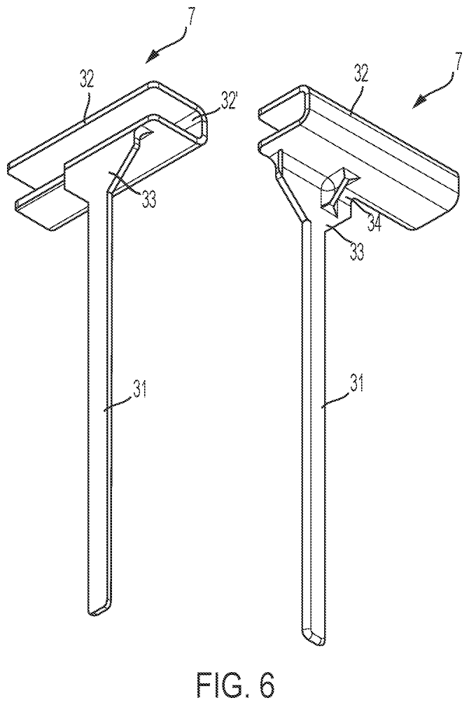

With reference to the Figures, FIG. 1 illustrates an adjustable compartment food slicer safety device 1, hereinafter referred to as safety device 1 or device 1. Generally, the device 1 includes a box compartment 2 with a pusher plate 4 and handle 5, a removable lid 6, and a blade guard 7. In an embodiment, the box compartment 2 is comprised of multiple metal, or other durable material, sheets, coupled together to create a bottom, a back side, and two sides (e.g., a left side and right side, as illustrated). In a different embodiment, a single metal, or other durable material, sheet is folded to form each of the bottom, back side, and two sides. Device 1 includes handles 3, which are coupled to the two sides of the box compartment 2. In an embodiment, the handles 3 can be selectively removable. In addition, the handles 3 can include a non-slip coating, texture, and/or grip. The box compartment 2 has an open front side and a closed perforated back side. In an embodiment, the handle 5 for the pusher plate 4 extends through one of the perforations on the back side and translates relative to pusher plate 4 through the perforation. The handle 5 for the pusher plate 4 can also include a non-slip coating, texture, and/or grip. Further, the blade guard 7 is disposed on a side of the box compartment 2 and faces the front of the box compartment 2. As illustrated, blade guard 7 is disposed on the left side of box compartment 2; in an alternate embodiment, blade guard 7 is disposed on the right side of box compartment 2. As such, the blade guard 7 flanks the left or right, open front of side of the box compartment 2, perpendicular to the bottom of the box compartment 2. The coupling of blade guard 7 to box compartment 2 is discussed in greater detail herein, for example, with reference to FIGS. 5 and 6.

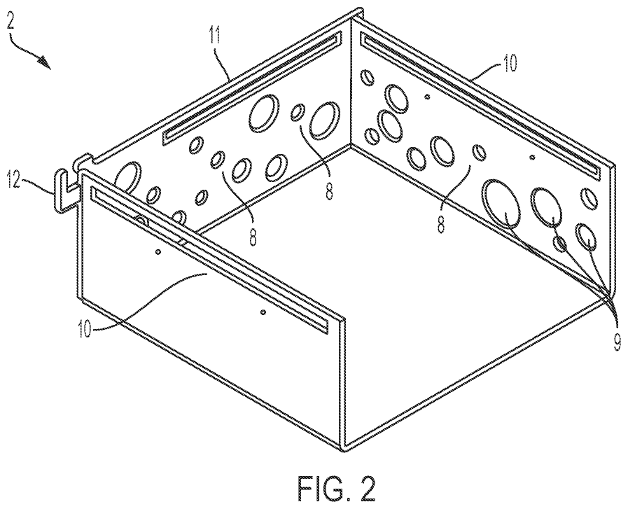

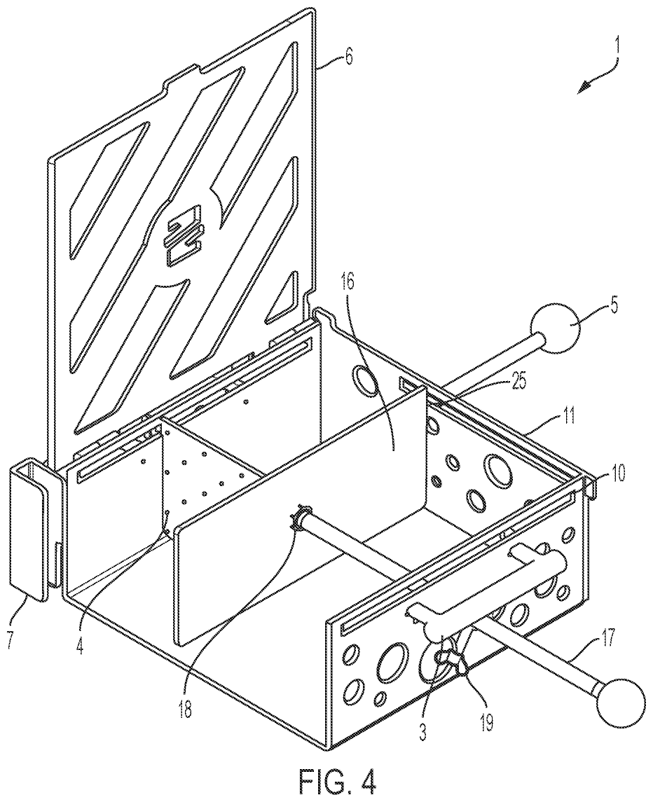

Continuing on, FIG. 2 illustrates an embodiment of the box compartment 2. In a specific example, the back side and the right side have handle perforations 8. The handle perforations 8 are sized for pusher handles 5 and divider handles 17 (shown in FIG. 4) to freely move in and out (as described further herein). Additionally, for example, the back side and the right side include additional randomized perforations 9, in various sizes, configured to lighten the overall weight of the box compartment 2 while simultaneously improving overall access and visibility to the contents of box compartment 2. The perforations 9 can also allow the user to insert, for example, a thermometer probe into meat in the box compartment 2, or to use probe tools to adjust the position of meat in the box compartment. As seen in FIG. 2, device 1 includes a pusher slot 10 on the top of each of the two sides of box compartment 2. Device 1 further includes an additional divider slot 11 on the top of the back side of the box compartment 2. Finally, the back side of the box compartment 2 also has a lid safety lock 12, configured to engage with removable lid 6 for selective locking and unlocking of removable lid 6. In another embodiment the lid safety lock 12, can be located elsewhere.

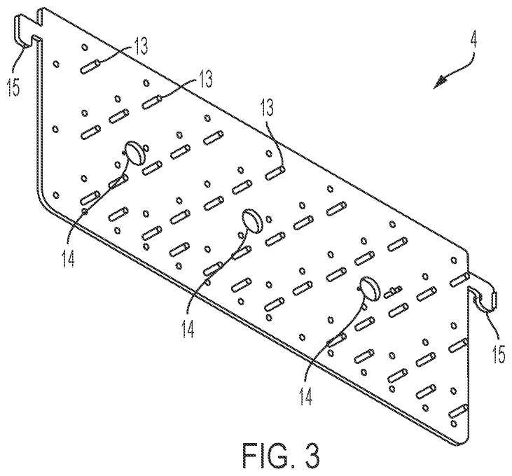

FIG. 3 illustrates an embodiment of the pusher plate 4. In FIG. 3, the pusher plate 4 is made of a metal, or other durable material, sheet with a plurality of metal protrusions or spikes 13 coupled to one side of the sheet. As such, the pusher plate 4 has a three-dimensional first side. Pusher plate 4 may further include a smooth or flat second side. The pusher plate 4 also has perforations 14 that are coupled on the second side with a threaded receptive portion, like a locknut, into which the threaded screw-like end of the pusher plate handle 5 can be fastened (seen in FIG. 1). In an alternate embodiment, the pusher plate 4 also includes additional randomized perforations (not shown) configured to lighten the overall weight of the pusher plate 4. It should be appreciated that the perforation geometries and the specific longitudinal and latitudinal perforation patterns, as well as the metal spikes 13, may vary in alternate embodiments. For example, the metal spikes 13 can have blunt ends for added safety, or sharp ends to pierce meat and further secure it in place.

Additionally, the pusher plate 4 has metal latches 15 on each side (e.g., along a top edge of the right side of pusher plate 4 and the left side of pusher plate 4). In this embodiment, the pusher plate 4 can be secured onto the box compartment 2 by inserting the metal latches 15 into the pusher slots 10 (seen in FIG. 2), and rotating the pusher plate 4 so as to interlock the metal latches 15 and pusher slots 10. More specifically, the pusher plate 4 is received by the box compartment 2 in a generally horizontal configuration, such that it is parallel with the pusher plate slots 10. In this way, the pusher plate slots 10 readily receive the metal latches 15. However, once the pusher plate 4 is rotated to a generally vertical configuration (e.g., perpendicular to the pusher plate slots 10 and the bottom of the box compartment 2), the metal latches 15 include geometry that prevents them from passing back through slots 10. In this way, the pusher plate 4 is “locked’ within slots 10. As such, the pusher plate 4 can translate horizontally within the box compartment 2, and device 1 (e.g., along slots 10), but cannot be readily removed from the box compartment 2, and device 1.

In an embodiment, the pusher plate 4, once secured by the metal latches 15 via pusher slots 10, is held upright by the pusher handle 5 passing from the back side of the box compartment 2, through one of the handle perforations 8, and fastened to the back side of the pusher plate 4 (e.g., via threaded engagement). Once secured and assembled, the user can use the pusher handle 5 to freely move the pusher plate 4 from the back side of the box compartment 2 toward the front of box compartment 2. FIG. 1 illustrates the aforementioned embodiment of the pusher plate 4, as assembled with the pusher handle 5 and disposed inside the box compartment 2.

Additionally, as a safety measure, the pusher slots 10 extend to the front of the box compartment 2 to a distance equal-to-or-longer than the distance of the metal spikes 13 on the spike side of the pusher plate 4. Namely, via the configuration of pusher slots 10, the user is unable to move the pusher plate 4 so as to make the metal spikes 13 make contact with the band saw blade during use.

FIG. 4 illustrates an embodiment of the safety device 1 in which there is not only a pusher plate 4, but also a divider plate 16 configured to secure smaller or oddly-shaped meats within box compartment 2. In this embodiment, the divider plate 16 has a metal latch 25, similar to latches 15 discussed above, which can be inserted into the divider slot 11 on the back side of the box compartment 2 to secure the divider plate 16 in place. In this embodiment, the divider plate 16 can be secured onto the box compartment 2 by inserting the metal latch 25 into the divider slot 11, and turning the divider plate 16 so as to interlock the metal latch 25 and divider slot 11. More specifically, the divider plate 16 is received by the box compartment 2 in a generally horizontal configuration, such that it is parallel with the divider slot 11. In this way, the divider slot 11 readily receives the metal latch 25. Once the divider plate 16 is rotated to a generally vertical configuration (e.g., perpendicular to the divider slot 11 and the bottom of the box compartment 2), the metal latch 25 includes geometry that prevents it from passing back through the divider slot 11. In this way, the divider plate 16 is “locked’ within the divider slot 11. As such, the divider plate 16 can translate horizontally within the box compartment 2, and device 1 (e.g., along slots 10), but cannot be readily removed from the box compartment 2, and device 1.

In an embodiment, the divider plate 16 is made of a solid metal, or other durable material, sheet that is smooth on both sides. However, one side of the divider plate 16 is coupled with a threaded receptive portion, like a locknut 18, into which the threaded screw-like end of the divider handle 17 can be fastened. As such, the divider plate 16, once secured by the metal latch 25 via divider slot 11, is held upright by the divider handle 17 passing from the side of the box compartment 2, through one of the handle perforations 8, and fastened to the back side of the divider plate 16 at the receptive portion 18. In this embodiment the divider handle 17 is coupled with fastening mechanism 19, such as a screw and wing nut, which allows the user to secure the divider handle 17 in place so as to immobilize the divider plate 16. As such, once the user decides on the relative position of the divider plate 16, they can secure it in place, such that the divider plate 16 remains fixed in relation to box compartment 2.

As seen in FIG. 4, in an embodiment the pusher plate 4 may vary in size (e.g., width) and can be used in combination with divider plates 16, so as to allow the user to feed differently-sized meats toward the band saw blade.

FIG. 5 illustrates an embodiment of the safety device 1 with a lid 6 secured in an open configuration. In this embodiment, the lid 6 is made of a metal, or other durable material, sheet and has various perforations 24 so as to enable the user to view the contents of the device 1 when the lid 6 is secured and lowered into a closed position (e.g., during slicing operations). Lid perforations 24 can vary in additional embodiments. Additionally, the perforations 24 can also allow the user to insert, for example, a thermometer probe into meat in the box compartment 2, or to use probe tools to adjust the position of meat in the box compartment.

Generally, the lid 6 may be secured into place with the box compartment 2 by way of lid safety lock 12. Namely, the lid 6 is inserted into box compartment 2, perpendicular to the bottom of the box compartment 2 and slid into the safety lock 12, so that the lid 6 is secured in place in the closed position by interlocking with safety lock 12. More specifically, in this embodiment, the lid 6 is received by the box compartment 2 in a generally vertical configuration, such that it is parallel with the safety lock 12 and sides of the box compartment 2. In this way, the safety lock 12 readily receive the lid 6. Once the lid 6 is rotated to a closed position, where it is in a generally horizontal configuration (e.g., parallel to the bottom of the box compartment 2), the safety lock 12 includes geometry that prevents the lid from disengaging with the safety lock 12. In this way, the lid 6 is “locked’ within the box compartment 2. As such, the lid 6 can move from a closed to open position relative to the box compartment 2 but cannot be readily removed from the box compartment 2 when it is in the closed position. This allows for use of the device 1 with the lid 6 open (e.g., with larger pieces of meat) and with the lid 6 closed. This ensures that if an irregular piece of meat pops or jumps during the cutting process, it is contained by the closed lid 6 and box compartment 2, and injury is avoided.

In this embodiment, the safety device 1 can be secured to the band saw table by way of locking clips 22 and tightening locks 23 coupled to a side of the box compartment 2. Specifically, the locking clips 22 are coupled to the side of the box compartment 2; the locking clips 22 interlock with the standard grooves found in band saw tables. Additionally, in this embodiment, one of the locking clips 22 is coupled with a tightening lock 23, which can be a screw and wing nut, so that once the user places the box compartment 2 on a band saw table and interlocks the locking clips 22 with table grooves, the user may implement the tightening lock 23 to secure the device 1 onto the table. As such, this embodiment serves to stabilize the device 1, so that it does not slip during use and potentially cause injury to the user. The number, placement, and type of locking clips 22 or mechanism may vary in other embodiments.

FIG. 5 also illustrates a blade guard 7 which is disposed on the side of the box compartment 2 and is secured in place via a guard aperture 20 and guard lock 21. The guard lock 21 can be a fastening mechanism, like a screw and wing nut, which is coupled to the guard aperture 20. The blade guard 7 slides into guard aperture 20, which is coupled to the side of the box compartment 2. More specifically, the support bracket 31 of the blade guard 7 slides into a receiving portion of the guard aperture 20 such that the blade receptacle 32 (shown in FIG. 6) faces the inside of the box compartment 2. The support bracket 31 engages with the guard aperture 20 such that the blade guard 7 translates horizontally on the side of the box compartment 2, so as to allow the user to adjust the distance between the blade guard 7 and the front of the box compartment 2. As such, by changing the aforementioned position of blade guard 7, the user can cut meats at different thicknesses. More importantly, once the user determines blade guard 7 position desired, by adjusting the support bracket 31 position, they can use the guard lock 21 to secure support bracket 31 in place and, thereby, secure the blade guard 7. Securing the blade guard 7 in place prevents shifting during device 1 use and, as such, prevents potential accidents.

FIG. 6 shows detailed views of one embodiment of the blade guard 7. The blade guard 7 can be made of metal, for example, or another material that withstands direct contact with a blade. The blade guard 7 includes a support bracket 31, a guard reinforcer 33, and a blade receptacle 32. In this embodiment, the support bracket 31 has a long, rectangular shape and it connects to the guard reinforce 33 on one end. The guard reinforcer 33 is shaped such that it is narrower on one end, where it connects with the support bracket, and gradually widens to connect to the midpoint of the blade receptacle 33 on the other end. The reinforcer 33 connects to front, open end of the blade receptacle 33. The connection point between the reinforcer 33 and the blade receptacle 32 may include an additional support point 34 to strengthen the structural stability of the blade guard 7. Additionally, the blade receptacle 32 has a wraparound shape that includes two sides and a back, such that it has an inside envelope 32′ that receives a blade.

As illustrated in FIG. 5, in a particular embodiment, using the safety device 1 includes cutting meat in the illustrated direction 30, relative to the front side of the box compartment 2. More specifically, in this embodiment, the blade guard 7 sits on the right-most side of the box compartment, so as to ensure that when the user moves the device 1 so that the blade moves from left to right, they end their cut at or near the blade guard 7. For example, at a cut's conclusion, blade receptacle 32′ receives the cutting portion of the band saw. Additionally, in moving the device 1 from left to right, the user can utilize the handles 3 on both sides of the box compartment 2, so that they do not make manual contact with cold or frozen meat during the cutting process.

While this application generally discusses blade guard 7 and safety device 1 for use with a band saw, it should be appreciated that other cutting devices (e.g., rotating and/or circular saw are likewise contemplated herein).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A safety device, comprising:
a main compartment;
a blade guard;
a pusher plate;
a divider plate; and
a compartment lid.

2. The safety device of claim 1, wherein each of the main compartment, the blade guard, the pusher plate, the divider plate, and the compartment lid are comprised of metal.

3. The safety device of claim 1, wherein the pusher plate includes a first side and a second side, wherein the first side includes a plurality of protrusions, and wherein the second side is flat.

4. The safety device of claim 3, wherein the second side is configured to be coupled with a first removable handle.

5. The safety device of claim 3, wherein the pusher plate is configured to be coupled to the main compartment via a slot and a latch.

6. The safety device of claim 1, wherein the divider plate is configured to be coupled with a second removable handle.

7. The safety device of claim 6, wherein the second removable handle is coupled to the main compartment via a fastening mechanism.

8. The safety device of claim 1, wherein the compartment lid interlocks with the main compartment.

9. The safety device of claim 1, wherein the compartment lid may be disposed in an open position or in a closed position, relative to the main compartment.

10. The safety device of claim 1, wherein the compartment lid is perforated.

11. The safety device of claim 1, wherein the main compartment includes a bottom, a back side, and two sides, and wherein the main compartment further includes an open front.

12. The safety device of claim 11, wherein the back side and the two sides are perforated.

13. The safety device of claim 1, wherein the main compartment is configured to be secured to a band saw table.

14. The safety device of claim 1, wherein the blade guard is configured to be secured onto one of the two sides of the main component.

15. The safety device of claim 1, wherein each of the main compartment, the blade guard, the pusher plate, the divider plate, and the compartment lid are comprised of a non-metal, durable material.

16. A blade guard configured to be disposed on a safety device, the blade guard comprising a blade receptacle and a support bracket, wherein the blade receptacle is disposed perpendicular to a bottom of the safety device when the blade receptacle receives a portion of a blade.

17. The blade guard of claim 16, wherein the support bracket is coupled to the blade receptacle at a mid-point of the blade receptacle.

18. The blade guard of claim 16, wherein the safety device includes an aperture configured to receive the support bracket.

19. The blade guard of claim 18, wherein the aperture is disposed along a side of the safety device.

20. The blade guard of claim 16, wherein the blade receptacle receives the portion of the blade after the blade has passed across a front of the safety device.
